(19) United States
(12) Patent Application Publication
(10) Pub. No.: US 2025/0075023 A1
(43) Pub. Date: Mar. 6, 2025

(54) POLYMERIC CARBODIIMIDES, PROCESSES FOR THE PREPARATION AND USE THEREOF

(71) Applicant: LANXESS DEUTSCHLAND GMBH, COLOGNE (DE)

(72) Inventor: Wilhelm Laufer, Ellerstadt (DE)

(73) Assignee: LANXESS DEUTSCHLAND GMBH, COLOGNE (DE)

(21) Appl. No.: 18/721,737

(22) PCT Filed: Dec. 20, 2022
(86) PCT No.: PCT/EP2022/086838

§ 371 Date: Jun. 19, 2024

(30) Foreign Application Priority Data
Dec. 23, 2021 (EP) 21217323.1

(51) Int. Cl. C08G 18/02; C08G 18/18; C08L 67/06

(52) U.S. Cl. CPC C08G 18/025; C08G 18/1883; C08L 67/06

(57) ABSTRACT

The invention relates to novel polycarbodiimides which are capable of easy and reliable production, have high average molar masses and effect excellent hydrolysis stabilization, to processes for the production thereof and to the use thereof.

Carbodiimides have proven advantageous in many applications, for example as hydrolysis inhibitors for thermoplastics, polyols, polyurethanes, triglycerides and lubricating oils.

These preferably employ highly sterically hindered polycarbodiimides. Highly sterically hindered aromatic polycarbodiimides with long polymer chains (high molar masses) have especially proven advantageous specifically for the stabilization of polyamides, polyethylene or polybutylene terephthalates and copolyesters such as TPE-E, thermoplastic polyurethane elastomers (TPU), rollable polyurethane elastomers and solvent-based polyurethane dispersions for coatings and paints. However, these highly sterically hindered and long-chain polycarbodiimides, for example those based on triisopropylphenyl isocyanate, have the disadvantage of being producible on a large industrial scale only with a considerable investment of time and equipment. Polycarbodiimides based exclusively on diisocyanates have very high viscosities and can still undergo uncontrollable polymerization even after the carbodiimidization step which entails various disadvantages, for example very costly and complex pelletization. Alternative production processes in solvent (crystallization) involve a plurality of process steps, are therefore costly and lead to products in powder form, thus necessitating additional compacting of the thus-obtained powder to avoid dusts in the end applications. Processes in this regard have already been described inter alia in EP176572 or EP2933285.

While end-capped aromatic polycarbodiimides are less difficult to produce, by comparison they do not show the desired high stabilization and are hazardous on account of toxic byproducts.

There was therefore a need for novel polycarbodiimides which do not exhibit the aforementioned disadvantages of the prior art, i.e. are easy and safe to manufacture, have high average molecular masses, are ideally nonhazardous and effect excellent hydrolysis stabilization. It was accordingly an object of the present invention to provide corresponding polycarbodiimides and a process for production thereof.

It has now been found that, surprisingly, the aforementioned object is achieved by polycarbodiimides of formula (I)

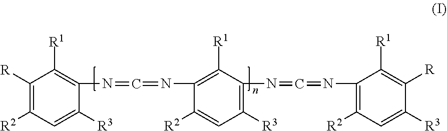

in which
the radicals R may be identical or different and are selected from NCN—R^{I}, wherein the radicals R^{I} represent C₁-C₂₂-alkyl, unsubstituted or C₁-C₁₂-alkyl-substituted C₆-C₁₂-cycloalkyl, unsubstituted or C₁-C₁₂-alkyl-substituted C₆-C₁₃-aryl or unsubstituted or C₁-C₁₂-alkyl-substituted C₆-C₁₃-aralkyl and
R¹, R² and R³ in each case identically or independently of one another represent methyl, ethyl, i-propyl- or n-propyl, n-butyl or i-butyl or t-butyl and n is from 20 to 500, preferably from 30 to 100, particularly preferably 30 to 50,
wherein the average molar mass Mw is more than 10 000 and the proportion of polycarbodiimides having a molar mass of 30 000 g/mol or more is less than 20% by weight. Since the chain length of the polycarbodiimides typically follows a distribution function the above definition of the repeating units n is not to be interpreted as meaning that the polycarbodiimides are free from compounds having a value n smaller or larger than the specified range. However, having regard to the specified average molar mass and the proportion of polycarbodiimides having a molar mass of 30 000 g/mol or more the proportion of such compounds is typically in a negligibly small range.

In a preferred embodiment R^{I} represents C₁-C₁₂-alkyl-substituted C₆-C₁₂-aryls, preferably C₁-C₄-alkyl-substituted C₆-C₁₂-aryls, particularly preferably mono- to tri-C₁-C₄-alkyl-substituted C₆-aryls and very particularly preferably di- and/or triisopropylphenyl.

Preference is given to polycarbodiimides of formula (I), wherein R¹, R² and R³ represent i-propyl- and R^{I} represents diisopropylphenyl and/or triisopropylphenyl. Particular preference is given to the embodiment in which the radicals R^{I} in a molecule are identical.

Also preferred are polycarbodiimides of formula (I) having average molar masses of 10 000 g/mol to 20 000 g/mol, preferably 12 000 g/mol to 18 000 g/mol, particularly preferably 14 000 g/mol to 16 000 g/mol. The average molar masses (Mw) are determined by gel permeation chromatography (GPC), preferably by the method described in the exemplary embodiments.

The proportion of polycarbodiimides having a molar mass of 30 000 g/mol or more is preferably less than 15% by weight, particularly preferably less than 12% by weight. The proportion of carbodiimides having a molar mass (M) of 30 000 g/mol is likewise determined by gel permeation chromatography (GPC).

The mass ratio of the radicals R to the radical of the compound of formula (I) is preferably in the range from 1:100 to 1:20.

The carbodiimide content (NCN content measured by titration with oxalic acid) of the carbodiimides according to the invention is typically 14-17% by weight, preferably 14-16% by weight, particularly preferably 14-15% by weight. To determine the NCN content, the NCN groups are reacted with oxalic acid added in excess and the unreacted oxalic acid is then potentiometrically back-titrated with sodium methoxide, taking into account the blank value of the system.

The polycarbodiimides according to the invention are exceptionally suitable for stabilizing ester-based polymers, preferably polymers selected from polyethylene terephthalate (PET), polybutylene terephthalate (PBT), polytrimethylene terephthalate (PTT), copolyesters such as modified polyesters of cyclohexanediol and terephthalic acid (PCTA), thermoplastic polyester elastomers (TPE E), ethylene vinyl acetate (EVA), polylactic acid (PLA) and/or PLA derivatives, polybutylene adipate-terephthalates (PBAT), polybutylene succinates (PBS), polyhydroxyalkanoates (PHA) and blends such as preferably PA/PET or PHA/PLA blends, polyurethane elastomers, preferably thermoplastic polyurethane elastomers (TPU), or rollable polyurethane, PU paints and coatings, preferably solvent-based dispersions.

The invention further relates to a process for stabilizing the above ester-based polymers by incorporating the polycarbodiimides according to the invention into the polymers. The abovementioned carbodiimides are preferably added to the ester-based polymers using solids metering units.

Solids metering units in the context of the invention are preferably: single-, twin- and multi-screw extruders, continuous co-kneaders (Buss-type) and discontinuous kneaders, for example Banbury-type.

The polycarbodiimides according to the invention are obtainable by a process for producing polycarbodiimides of formula (I)

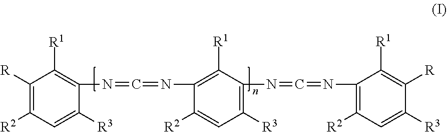

by carbodiimidization of aromatic diisocyanates of formula (II)

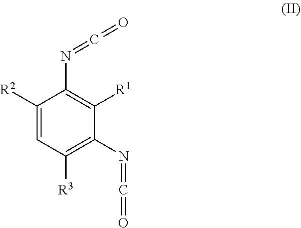

and monoisocyanates of formula R^{I}—NCO, wherein the radicals R, R¹, R², R³ and R^{I} and n are as defined above,
at temperatures of 80° C. to 200° C. in the presence of catalysts and optionally solvent to eliminate carbon dioxide,
characterized in that the diisocyanates and monoisocyanates are employed in a mass ratio of 20:1 to 100:1, preferably of 25:1 to 50:1 and particularly preferably of 30:1 to 40:1.

According to the prior art the synthesis of the polycarbodiimides of formula (I) is carried out by basic or heterocyclic catalysis. The catalysts typically used are alkali metal or alkaline earth metal compounds and also heterocyclic compounds containing phosphorus. Corresponding catalysts are for example described in Angew. Chem. 1962, 74, 801-806 and Angew. Chem. 1981, 93, 855-866.

The isocyanates used are particularly preferably 1,3,5-triisopropylphenyl diisocyanate (TRIDI), 2,6-diisopropylphenyl isocyanate (DIPI) or 2,4,6-triisopropylphenyl isocyanate (TRIPI).

In one embodiment of the invention the catalysts preferred for the carbodiimidization of the isocyanates to carbodiimides of formula (I) are strong bases or phosphorus compounds. Preference is given to using phospholene oxides, phospholidines or phospholine oxides and also the corresponding sulfides. Further catalysts that may be used are tertiary amines, basic metal compounds, alkali metal and alkaline earth metal oxides, hydroxides, alkoxides or phenoxides, metal carboxylates and non-basic organometallic compounds. Preferred catalysts particularly include alkylphospholene oxides such as for example methylphospholene oxide.

The reaction (carbodiimidization) is preferably conducted in a temperature range from 140° C. to 200° C., particularly preferably from 160° C. to 180° C.

In a preferred embodiment of the invention the isocyanates (diisocyanates and monoisocyanates) are first mixed together and then carbodiimidized as a mixture.

In a further embodiment first the diisocyanates of formula (II) are partially carbodiimidized in the presence of catalysts and optionally solvent and then the monoisocyanates of formula R^{I}—NCO are added to the reaction mixture to complete the carbodiimidization.

In a preferred embodiment the reaction mixture is stirred at elevated temperature, preferably at reaction temperature, under reduced pressure after the carbodiimidization and the residual content of isocyanates reduced to <0.1% by weight.

In a preferred variant of the invention the final reaction mass is finished into pellets or flakes in a pelletizing apparatus from Sandvik Holding GmbH for example or via a flake roller from GMF Gouda for example.

The present invention further provides compositions containing the polymeric carbodiimides according to the invention and ester-based polymers, preferably polymers selected from polyethylene terephthalate (PET), polybutylene terephthalate (PBT), polytrimethylene terephthalate (PTT), copolyesters such as modified polyesters of cyclohexanediol and terephthalic acid (PCTA), thermoplastic polyester elastomers (TPE E), ethylene vinyl acetate (EVA), polylactic acid (PLA) and/or PLA derivatives, polybutylene adipate-terephthalates (PBAT), polybutylene succinates (PBS), polyhydroxyalkanoates (PHA) and blends such as preferably PA/PET or PHA/PLA blends, polyurethane elastomers, preferably thermoplastic polyurethane elastomers (TPU), or rollable polyurethane, PU paints and coatings, preferably solvent-based dispersions. The weight ratio of polymeric carbodiimides to ester-based polymers is typically from 0.1:100 to 5:100, preferably from 0.5:100 to 4:100 and most preferably from 1:100 to 3:100.

The examples which follow serve to elucidate the invention but have no limiting effect.

### EXAMPLES

### Determination of Molar Mass:

Apparatus Instrument Ultimate 3000
   Detector RI ERC-7515A
   Combination of 3 columns (PSS SDV 5μ 100A, PSS SDV 5μ 500A and PSS SDV 5μ 10000A, Material PL-Gel 10e4 A, length 300 mm, diameter 8 mm)
   PSS WinGPC-Unichrom software
   Volumetric bottle 25 ml
   Pipetman 100 μl (±0.0001 g)
Reagents Standard samples
   Polystyrene standard (polydispersity index less than 1.2)
Solvents 2,6-di-tert-butyl-1,4-methylphenol (BHT)
   Tetrahydrofuran (THF)
   Toluene
Parameter V (Injection 100 μl quantities)
   Flow 1.0 ml/min
   Eluent THF
   Pressure 36 bar
   Temperature 40° C.

### Carbodiimidization

Pure 1,3,5-triisopropylphenyl diisocyanate (TRIDI) for CDI 1 or a mixture of 1,3,5-triisopropylphenyl diisocyanate (TRIDI) and 2,6-diisopropylphenyl iisocyanate (DIPI) for CDI 2, 4, 5 and 6 or a mixture of 1,3,5-triisopropylphenyl diisocyanate (TRIDI) and cyclohexanol was carbodiimidized at 160° C. in the presence of about 0.1% methylphospholene oxide until an NCO content of <1% was achieved.

The results are listed in Table 1 below.

Tests were carried out on:
1) CDI 1: Polycarbodiimide having an NCN content of about 14% by weight, conforming to formula (I) with R¹, R², R³=isopropyl and R=NCO and produced from 1,3,5-triisopropylphenyl diisocyanate (comparative example)
2) CDI 2: Polycarbodiimide having an NCN content of about 13.5% by weight, conforming to formula (I) with R¹, R², R³=isopropyl and R=NCN—R^{I} where R^{I}=2,6-diisopropylphenyl and produced from about 80% by weight 1,3,5-triisopropylphenyl diisocyanate and 20% by weight 2,6-diisopropylphenyl isocyanate (comparative example).
3) CDI 3: Polycarbodiimide having an NCN content of about 12.5% by weight, conforming to formula (I) with R¹, R², R³=isopropyl and R=oxocyclohexyl and produced from about 80% by weight 1,3,5-triisopropylphenyl diisocyanate and 20% by weight cyclohexanol (comparative example).
4) CDI 4: Polycarbodiimide having an NCN content of about 14% by weight, conforming to formula (I) with R¹, R², R³=isopropyl and R=NCN—R^{I} where R^{I}=2,6-diisopropylphenyl and produced from about 92.5% by weight 1,3,5-triisopropylphenyl diisocyanate and 7.5% by weight 2,6-diisopropylphenyl isocyanate (comparative example).
5) CDI 5: Polycarbodiimide having an NCN content of about 14.5% by weight, conforming to formula (I) with R¹, R², R³=isopropyl and R=oxocyclohexyl and produced from about 97% by weight 1,3,5-triisopropylphenyl diisocyanate and 3% by weight cyclohexanol (comparative example).
6) CDI 6: Polycarbodiimide having an NCN content of about 14% by weight, conforming to formula (I) with R¹, R², R³=isopropyl and R=NCN—R^{I} where R^{I}=2,6-diisopropylphenyl and produced from about 97% by weight 1,3,5-triisopropylphenyl diisocyanate and 3% by weight 2,6-diisopropylphenyl isocyanate (inventive).

TABLE 1

| | | Stability at 180° C., 4 h | | | Proportion |
|---|---|---|---|---|---|
| | | polymerization state, | Pelletizability/pellet | Mw in | monomeric |
| Ex. | Carbodiimide | solubility in toluene | form | g/mol | carbodiimide |
| 1 | CDI 1 | polymerized/partially | difficult, formation of | about | <0.1% by |
| | (comp.) | soluble | threads/irregular | 17 000 | weight |
| | | | shape and size | | |
| 2 | CDI 2 | no further | very good, same | about | about 1.8-2% |
| | (comp.) | polymerization/soluble | shape and size | 3000 | by weight |
| 3 | CDI 3 | polymerized/insoluble | very difficult, no pellet | about | — |
| | (comp.) | | form possible | 9000 | |
| 4 | CDI 4 | no further | very good, same | about | about 0.35% |
| | (inv.) | polymerization/soluble | shape and size | 8000 | by weight |
| 5 | CDI 5 | polymerized/insoluble | not possible | about | — |
| | (comp.) | | | 12 000 | |
| 6 | CDI 6 | no further | good, same shape | about | <0.1% by |
| | (inv.) | polymerization/soluble | and size | 15 000 | weight |

comp .: comparative example, inv .: inventive

As is apparent from Table 1 only the inventive polycarbodiimide is capable of relatively easy and reliable production and finishing (no risk of runaway polymerization in the reactor or in the conduits to and in the finishing region such as a flake roller or pelletizing belt) and simultaneously shows the desired molar mass (Mw>10 000 g/mol) and a reduced proportion of toxic monomeric carbodiimide below the relevant limit of 0.1% by weight. The emission characteristics are moreover reduced with longer polymer chains and a low proportion of monomeric carbodiimide.

### Hydrolysis Inhibition in Polyethylene Terephthalate (PBT)

To evaluate the hydrolysis inhibition in PET 2.5% by weight respectively of the carbodiimides investigated were dispersed into PET using a ZSK 25 laboratory twin screw extruder from Werner & Pfleiderer prior to the measurement described below. F3 standard test specimens for measurement of breaking strength were then produced from the resultant granulates in an Arburg Allrounder 320 S 150-500 injection-moulding machine.

For the hydrolysis test, these F3 standard test specimens were stored in water at a temperature of 120° C. and the breaking strength thereof was measured in MPa. Table 2 shows the relative breaking strengths=(breaking strength after x days of storage/breaking strength after 0 days)×100. A lower limit for relative breaking strength is usually 70-75%.

The results are shown in Table 2:

| | Relative tear resistance | | | | | |
|---|---|---|---|---|---|---|
| | Ex. 7: | | | | | |
| Hydrolysis | without | Ex. 8: | | Ex. 10: | Ex. 11: | Ex. 12: |
| duration | CDI | CDI 1 | Ex. 9: CDI | CDI 3 | CDI 4 | CDI 6 |
| (days) | (comp.) | (comp.) | 2 (comp.) | (comp.) | (comp.) | (inv.) |
| 0 | 100% | 100% | 100% | 100% | 100% | 100% |
| 1 | 100% | 100% | 100% | 100% | 100% | 100% |
| 2 | 51% | 100% | 100% | 100% | 100% | 100% |
| 3 | — | 100% | 100% | 100% | 100% | 100% |
| 4 | — | 100% | 100% | 100% | 100% | 100% |
| 5 | — | 100% | 48% | 40% | 100% | 100% |
| 6 | — | 100% | — | — | 100% | 100% |
| 7 | — | 100% | — | — | 75% | 100% |
| 8 | — | 100% | — | — | — | 100% |
| 9 | — | 69% | — | — | — | 81% |
| 10 | — | — | — | — | — | — |

comp. = comparative example, inv. = inventive

### Dispersibility and Compatibility in Polyurethane-Based Formulations and in Rollable Polyurethane

Table 3 shows the results of the compatibility tests in DMF/polyurethane dispersions and in rollable polyurethane elastomer (Urepan®, LANXESS Deutschland GmbH)

| | | Proportion | Dispersibility/solubility | |
|---|---|---|---|---|
| | poly- | M > 30 000 | Rollable | |
| Ex. | carbodiimide | g/mol | polyurethane | DMF/PU dispersion |
| 13 | CDI 1 (comp.) | 22 wt % | very poor, | no homogeneous and |
| | | | formation | stable dispersion |
| | | | of spots | |
| 14 | CDI 6 (inv.) | 10 wt % | homogeneous, | homogeneous and |
| | | | no spots | stable dispersion |

comp. = comparative example, inv. = inventive

As is apparent from Table 3, compared to the polycarbodiimide from the prior art the inventive polycarbodiimide invention leads to stable and homogeneous polyurethane formulations due to better dispersibility and solubility. It is also apparent that a lower proportion of higher molecular weight polymer chains of more than 30 000 g/mol in the inventive polycarbodiimide significantly improves compatibility in many applications and formulations.

1. A polycarbodiimide of formula (I) 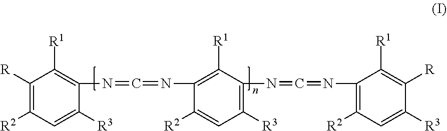
in which
the radicals R may be identical or different and are selected from NCN—R^{I}, wherein the radicals R^{I} represent C₁-C₂₂-alkyl, unsubstituted or C₁-C₁₂-alkyl-substituted C₆-C₁₂-cycloalkyl, unsubstituted or C₁-C₁₂-alkyl-substituted C₆-C₁₃-aryl or unsubstituted or C₁-C₁₂-alkyl-substituted C₅-C₁₈-aralkyl and
R¹, R² and R³ in each case identically or independently of one another represent methyl, ethyl, i-propyl- or n-propyl, n-butyl or i-butyl or t-butyl and
n is from 20 to 500,
wherein the average molar mass Mw is more than 10000 and the proportion of polycarbodiimide having a molar mass of 30,000 g/mol or more is less than 20% by weight.

2. The polycarbodiimide according to claim 1, wherein the average molar mass is from 10,000 g/mol to 20,000 g/mol.

3. The polycarbodiimide according to claim 1, wherein the proportion of polycarbodiimid having a molar mass of 30,000 g/mol or more is less than 15% by weight.

4. The polycarbodiimide according to claim 1, wherein R^{I} represents C₁-C₁₂-alkyl-substituted C₆-C₁₂-aryls.

5. The polycarbodiimide according to claim 1, wherein R¹, R² and R³ represent i-propyl and R^{I} represents diisopropylphenyl and/or triisopropylphenyl.

6. The polycarbodiimide according to claim 1, wherein the mass ratio of the radicals R to the radical of the compound of formula (I) is in the range from 1:100 to 1:20.

7. The polycarbodiimide according to claim 1, wherein the carbodiimide content is 14-17% by weight.

8. A process for producing polycarbodiimides of formula (I) 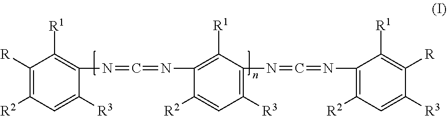
by reaction of diisocyanates of formula (II) 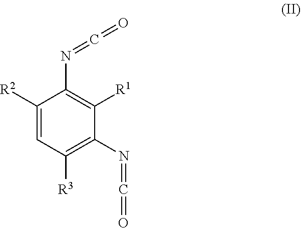
and monoisocyanates of formula R^{I}—NCO,
wherein the radicals R may be identical or different and are selected from NCN—R^{I}, wherein the radicals R^{I} represent C₁-C₂₂-alkyl, unsubstituted or C₁-C₁₂-alkyl-substituted C₆-C₁₂-cycloalkyl, unsubstituted or C₁-C₁₂-alkyl-substituted C₆-C₁₂-aryl or unsubstituted or C₁-C₁₂-alkyl-substituted C₁-C₁₈-aralkyl and
R¹, R² and R³ in each case identically or independently of one another represent methyl, ethyl, i-propyl- or n-propyl, n-butyl or i-butyl or t-butyl and
n is from 20 to 500, at temperatures of 80° C. to 200° C. in the presence of catalysts and optionally solvent to eliminate carbon dioxide,
wherein the mass ratio of diisocyanates to monoisocyanates is from 20:1 to 100:1.

9. The process according to claim 8, wherein the diisocyanates of formula (II) are first mixed with the monoisocyanates of formula R^{I}—NCO and then heated to the reaction temperature and reacted as a mixture.

10. The process according to claim 8, wherein first the diisocyanates of formula (II) are partially carbodiimidized in the presence of catalysts and optionally solvent and then the monoisocyanates of formula RI—NCO are added to the reaction mixture to complete the carbodiimidization.

11. The process according to claim 8, wherein after reaction the mixture is stirred at elevated temperature under reduced pressure, the residual content of isocyanates is reduced to <0.1% by weight.

12. The process according to claim 8, wherein the polycarbodiimides obtained during the reaction are pelletized on a cooling belt or are finished into flakes on a flake roller.

13. The process according to claim 8, wherein the reaction is carried out at a temperature of 160° C. to 180° C.

14. (canceled)

15. (canceled)

16. A method of stabilizing an ester-based polymer comprising incorporating the polycarbodiimide according to claim 1 into the ester-based polymer.

17. The method according to claim 16, wherein the ester-based polymer is selected from polyethylene terephthalate (PET), polybutylene terephthalate (PBT), polytrimethylene terephthalate (PTT), copolyesters, thermoplastic polyester elastomers (TPE E), ethylene vinyl acetate (EVA), polylactic acid (PLA) and/or PLA derivatives, polybutylene adipate-terephthalates (PBAT), polybutylene succinates 30 (PBS), polyhydroxyalkanoates (PHA) and blends thereof, and polyurethane elastomers.

18. The method according to claim 16, wherein R¹, R² and R³ represent i-propyl, R^{I} represents diisopropylphenyl and/or triisopropylphenyl, and the ester-based polymer is polyethylene terephthalate (PBT).

19. A homogeneous composition comprising an ester-based polymer and the carbodiimide according to claim 1.

20. The composition according to claim 19, wherein R¹, R² and R³ represent i-propyl and R^{I} represents diisopropylphenyl and/or triisopropylphenyl.

21. The composition according to claim 20, wherein the ester-based polymer is selected from polyethylene terephthalate (PET), polybutylene terephthalate (PBT), polytrimethylene terephthalate (PTT), copolyesters, thermoplastic polyester elastomers (TPE E), ethylene vinyl acetate (EVA), polylactic acid (PLA) and/or PLA derivatives, polybutylene adipate-terephthalates (PBAT), polybutylene succinates 30 (PBS), polyhydroxyalkanoates (PHA) and blends thereof, and polyurethane elastomers.

22. The composition according to claim 21, wherein the ester-based polymer is polyethylene terephthalate (PBT), DMF/polyurethane dispersion, or rollable polyurethane elastomer.
